(19) United States
(12) Patent Application Publication
(10) Pub. No.: US 2007/0199790 A1
(43) Pub. Date: Aug. 30, 2007

(54) Process and device for adjusting a friction clutch located in a drive train of a vehicle and actuated by an actuator

(75) Inventors: Jeremy Whitmer, Lakewood, OH (US); Brad Shellhammer, Chippewa Lake, OH (US); Ben Roberts, Orrville, OH (US); David Smith, Wadsworth, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/706,534

(22) Filed: Feb. 15, 2007

Related U.S. Application Data
(60) Provisional application No. 60/773,927, filed on Feb. 16, 2006.

(51) Int. Cl. F16D 13/75

(52) U.S. Cl. 192/70.252; 192/111.16

(57) ABSTRACT

A process for adjusting a friction clutch located in a drive train of a vehicle and actuated by an actuator, the friction clutch comprising an adjustment device which, on moving an actuation element beyond a displacement range, effects a clutch adjustment compensating for friction lining wear, the process comprising the following steps: determining whether the drive train of the vehicle is in a state in which an adjustment of the clutch is possible; determining whether an adjustment of the clutch is necessary; moving the actuation element beyond the theoretical range so that the adjustment device carries out an adjustment; activating a slip-control process of the clutch; determining whether an adjustment has taken place; and, updating the engagement point of the clutch.

### CROSS-REFERENCE TO RELATED APPLICATIONS

This patent application claims the benefit under 35 U.S.C. §119(e) of U.S. Provisional Application No. 60/773,927, filed Feb. 16, 2006, which application is incorporated herein by reference.

### FIELD OF THE INVENTION

The invention relates to a process and device for adjusting a friction clutch located in a drive train of a vehicle and actuated by an actuator.

### BACKGROUND OF THE INVENTION

Friction clutches, in particular dry-running friction clutches, due to the wear of the friction lining, or friction linings, must be adjusted again and again. This usually happens via an adjustment device integrated into the friction clutch, said adjustment device at least approximately reproducing the relationship between the position of an actuation element and the torque transferable by the clutch, said position changing with wear of the friction lining, or friction linings.

In modern motor vehicles, automated clutches, or clutches controlled by an actuator, are increasingly being used, said clutches unburdening the driver and enabling the use of automated manual transmissions. Recently finding application in motor vehicles are parallel shift gearboxes or twin-clutch transmissions with which driving force can be shifted without interruption and whose efficiency is improved with respect to planetary transmissions working with converters.

Such parallel shift gearboxes comprise two sub-transmissions with which the odd or the even gears are shifted, where, when driving in an odd gear, a clutch associated with the sub-transmission with the odd gears is closed and the clutch associated with the sub-transmission with the even gears is open so that in this sub-transmission an even gear can be pre-selected or engaged to which one can shift by opening the clutch associated with the sub-transmission with the odd gears and closing the clutch associated with the sub-transmission with the even gears. Since, at least when one gear is engaged in both sub-transmissions, both clutches may not be closed at the same time, these clutches are usually formed as spring-loaded clutches, that is, as clutches which are closed by means of an actuator working against the force of an opening spring and which, due to the opening spring, automatically assume their open position when the actuator is not energized.

For precise controllability of these clutches a wear compensation or wear adjustment is necessary. This wear adjustment must be done automatically and without driving comfort being impacted.

### SUMMARY OF THE INVENTION

The invention is based on the objective of specifying a process for adjusting a friction clutch located in a drive train of a vehicle and actuated by an actuator, where said process can be carried out without driving comfort being impacted, that is, without the occupants of the vehicle noticing it. The invention is in addition based on the objective of specifying a device for carrying out such a process.

A process according to the invention and for adjusting a friction clutch located in a drive train of a vehicle and actuated by an actuator, said friction clutch comprising an adjustment device which, on moving an actuation element beyond a displacement range, effects a clutch adjustment compensating for friction lining wear, said process comprising the following steps:
determining whether the drive train of the vehicle is in a state in which an adjustment of the clutch is possible,
determining whether an adjustment of the clutch is necessary,
moving the actuation element beyond the theoretical range so that the adjustment device carries out an adjustment,
activating a slip-control process of the clutch,
determining whether an adjustment has taken place, and
updating the engagement point of the clutch.

In an advantageous form of implementation of the process according to the invention the friction clutch is pressed into its closed position by the actuation element and the adjustment device is activated by the actuation element being moved beyond a theoretical closed position of the clutch.

To determine that the vehicle drive train is in a state in which an adjustment of the clutch is possible it must be the case that, for example, at least one of the following operating states of the drive train obtains:
suspension of slip control is not critical,
the motor torque is less than a predetermined value,
the rotary speed of the clutch input shaft exceeds a minimum rotary speed,
the gear has been shifted longer than a predetermined period of time,
the slip is less than an upper limit value,
no shifting process is activated.

The requirement of an adjustment of the clutch can be specified by the operating period of the clutch.

Alternatively, the requirement for an adjustment of the clutch can be specified by at least one of the following events:
reduction of the clutch torque which can be transferred during a predetermined actuation of the actuation element,
shift of the engagement point,
reduction of the force to be applied to the actuation element located at a predetermined position,
a calculated wear value exceeds a predetermined wear value.

For triggering an adjustment process the actuation element can be moved beyond the theoretical range according to one of the following control processes:

path control, force control, speed control.

After carrying out an adjustment with a combination of torque control and slip control it is advantageous to return to slip control.

Whether an adjustment is necessary can, for example, be checked in such a manner that at least one point of an actual characteristic curve for a clutch stored before the activation of an adjustment is compared to one point of a characteristic curve present after the adjustment.

The actual characteristic curve can subsequently be adapted according to the deviation determined.

A device for adjusting a friction clutch located in a drive train of a vehicle, actuated by an actuator, and comprising an adjustment device which, on moving an actuation element beyond a displacement range, effects a clutch adjustment compensating for friction lining wear, comprising the actuator for actuating the actuation element, sensors for determining the clutch slip, the torque transferred by the clutch, and the position of the actuation element and an electronic control device for controlling the actuator as a function of clutch slip, of clutch torque, and in given cases of additional operational parameters of the drive train, said control device comprising at least one characteristic curve for a clutch, said characteristic curve including the torque transferable by the clutch as a function of the position of the actuation element and being suitable for carrying out the aforementioned process.

In an advantageous form of embodiment of the device according to the invention the clutch is a clutch comprised in a parallel shift gearbox.

The invention, which can be applied to essentially all friction clutches impacted by wear, will be explained in the following by way of example and with additional details with the aid of a clutch, such as, for example, is comprised in a parallel shift gearbox and is pressed by an actuator into the closed position.

### BRIEF DESCRIPTION OF THE DRAWINGS

Shown in the figures are:

FIG. 1 is a schematic representation of a clutch actuation device;

FIG. 2 is an extract of a longitudinal section through a twin clutch of a parallel shift gearbox;

FIG. 3 illustrates characteristic curves for a clutch to explain the action of adjustment for wear;

FIG. 4 illustrates curves to explain an adjustment;

FIG. 5 is a flow chart to explain the invention; and,

FIG. 6 is a load-based and a position-based clutch lever.

### DETAILED DESCRIPTION OF THE INVENTION

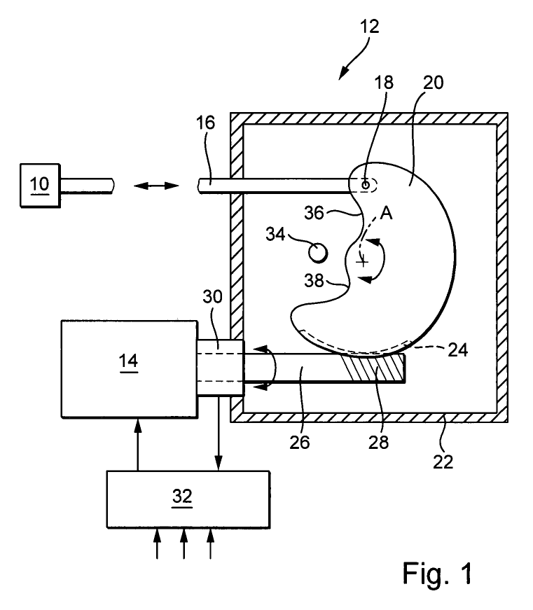

According to FIG. 1 a clutch, designated overall by 10, e.g., a clutch of a parallel shift gearbox, is connected, via a force-conducting mechanism designated overall by 12, to an actuator, in the represented example, electric motor 14.

Clutch 10 is of the type of construction known per se in which the clutch must be impelled into its closed, or torque-transmitting, state against the force of an opening spring internal to the clutch.

The force-conducting mechanism comprises actuation element 16 which is connected directly, via additional coupling elements, or via a hydraulic transmission path to a clutch lever whose position determines the torque which can be transmitted by the clutch.

Actuation element 16 is connected, via bearing 18, to segmented wheel 20, which is mounted in such a manner that it can rotate about axis A in housing 22. Housing 22 can be connected in a fixed manner to the housing of the clutch or to a transmission housing.

Segmented wheel 20 comprises, on a circumferential area, toothing 24 which meshes with spiral threading 28 formed on output shaft 26 of electric motor 14. To detect turning of output shaft 26 increment counter 30 is provided.

Electronic control device 32 with a microprocessor and associated storage devices serves to control electric motor 14, where one input is connected to increment counter 30 and additional inputs are connected, in given cases via a bus, to outputs of sensors or another control device, where via these outputs control device 32 is supplied with data relevant to the operation of clutch 10. One output of control device 32 is connected to electric motor 14.

The ability of segmented wheel 20 to turn is limited by at least one stop 34 where a stop face 36 abuts at the end of the actuation movement of actuation element 16 into the closed position of the clutch. The ability of segmented wheel 20 to turn into the open position of clutch 10 is also limited by the fact that additional stop face 38 comes to abut stop 34.

The engagement between spiral threading 28 and toothing 24 is advantageously not self-inhibiting so that, in the absence of voltage energization of electric motor 14, clutch 10 moves, under the force of the opening spring not represented, into the open position.

The design and function of the arrangement described are known per se and will thus not be explained further.

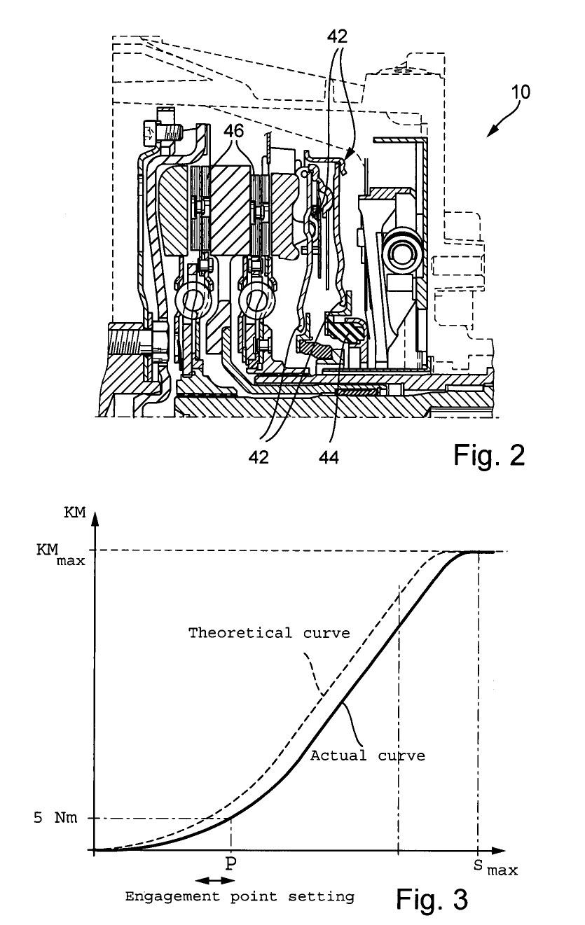

FIG. 2 shows an extract of twin clutch 10 known per se, as it is comprised in a parallel shift gearbox. During an adjustment, adjustment device 40 integrated into this twin clutch moves lever spring 42 outwards. An adjustment takes place if engagement bearing 44 is moved further than its normal displacement path to complete the closure of the clutch (in so doing contacting stop 36 but not stop 34) and friction linings 46 are sufficiently worn for an adjustment. The adjustment device per se is not a component of the invention and is thus not explained in more detail.

FIG. 3 represents the clutch torque KM as a function of the displacement s of engagement bearing 46, or of actuation element 16, from the open position into the closed position. The dashed curve is a theoretical curve which is stored in control device 32 and, for example, corresponds to the new state of the clutch. This theoretical curve serves, for example, for a rapid pilot control of the clutch. With increasing actuation of the actuation element, or increasing value s, the transferable clutch torque KM increases up to a maximum value KMₘₐₓ, which is coordinated to the maximum torque occurring in the drive train and above which no slip occurs. If the actuation element is moved beyond the position corresponding to the maximum torque, the adjustment device 42 (FIG. 2) begins to function. This happens approximately above a position sₘₐₓ of the actuation element.

If the friction linings wear, the actuation path s which is necessary for a predetermined clutch torque increases, that is, the dashed theoretical curve passes above the solid actual curve.

As can be seen, the engagement point P of the clutch is shifted to increasingly higher displacement paths s depending on the clutch wear. The engagement point is that point at which the transferable clutch toque is approximately 5 Nm. Precise knowledge of the engagement point is necessary for a precise clutch control.

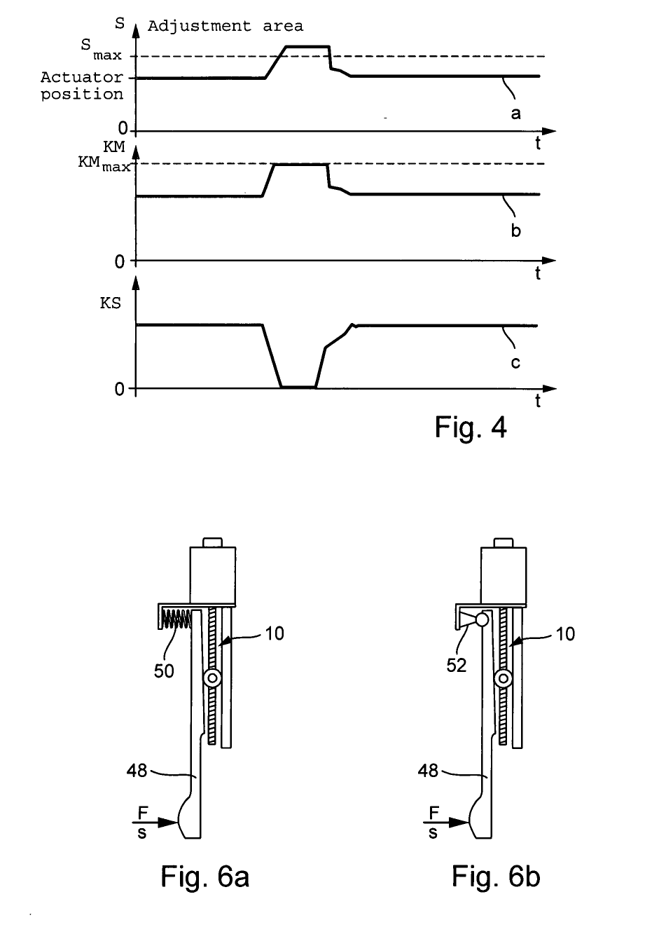

FIG. 4 shows three diagrams to explain several functions during an adjustment. For all the curves the horizontal represents the time. The curve a describes the position s of the actuation element, or of the engagement, bearing, as a function of time. On overshoot of the value sₘₐₓ an adjustment takes place. The curve b describes the clutch torque KM. During the adjustment the maximum clutch torque KMₘₐₓ can be transferred.

The curve c describes the clutch slip KS. Before and after the adjustment the clutch is operated with a slip. During the adjustment there is no slip.

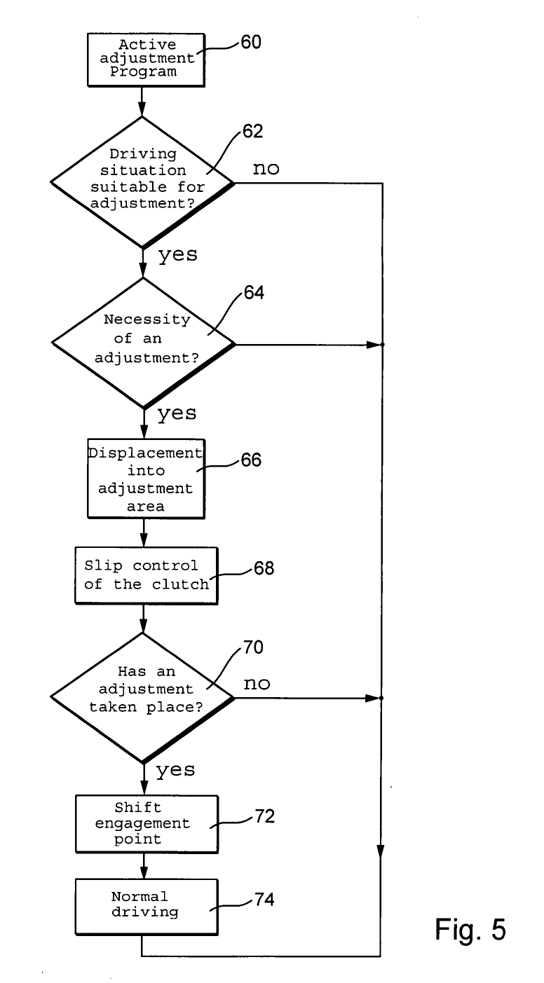

In the following, the invention will be described by way of example with the aid of the flow chart according to FIG. 5.

Let it be assumed that the vehicle is driving forward in a forward gear and an adjustment program is activated in step 60 within which the clutch is intended to be adjusted to compensate for wear. This activation can, for example, be done under routine control or after each startup of the vehicle.

In step 62 it is checked whether the existing driving situation is suitable for an adjustment. An adjustment in which the clutch, as can be seen from FIGS. 3 and 4, is brought into a reliably slip-free state and the actuation element is moved beyond the normal displacement path for the clutch, is possible if predetermined conditions are met:
Modern clutches are frequently operated under slip control, that is, they are controlled in such a manner that there is a predetermined slip, depending on the particular point of operation, with which the irregularities in turning are compensated, as they are, for example, present during driving at very low rotary speeds or are controlled during shifting, depending on the acceleration and comfort desired. An adjustment, during which the clutch reaches the slip-free state, is thus only possible if a suspension of the slip control is not critical, that is, leads to no impacts on comfort. Numbering among such impacts is possible toothing noise, which can occur at low rotary speeds and with slip suspended.
During the adjustment, the rotary speed of the input shaft of the clutch should be above a minimum rotary speed.
Likewise, the rotary speed of the motor should be above a minimum rotary speed.
The motor torque should be less than a predetermined value which can be a function of the rotary speed and increases with increasing rotary speed.
The gear in which driving is taking place should already have been shifted longer than a predetermined period of time.
The slip with which the clutch is running should be less than an upper limit value. With this, it is ensured that a sudden suspension of slip does not lead to undesirable impacts on comfort.
No shifting process should be activated.

The conditions above do not all have to be met simultaneously. It is advantageous, however, if several of them are met since this indicates that an adjustment of the clutch or a compensation of wear will not lead to undesirable impacts on comfort.

In additional step 64 it is then checked whether the clutch adjustment is necessary. For this checking there are, for example, two possibilities which can be used individually or in combination.

Time-based

In a time-based decision concerning the necessity of an adjustment, for example, a predetermined period of operation of the clutch, where that period of operation is stored in control device 32 and has expired since the last adjustment, determines whether an additional adjustment is necessary or should be attempted.

Event-controlled

With event control the execution of an adjustment depends on events which indicate the necessity of an adjustment and are identified by the control device. Examples of such events are:

Reduced calculated maximum transferable clutch torque

Based on the instantaneous engagement point and the adhesion factor of the clutch as well as the end V (FIG. 3) of the displacement path stored in the control device of the actuation element, the calculated maximum transferable clutch torque decreases with increasing wear. Furthermore, a shift of the engagement point or a reduction of the clutch torque transferable with the engagement point held constant indicates wear of the friction linings.

With increasing wear there is a decrease in the pilot control voltage with which the actuator has to be energized so that the actuation element reaches a predetermined position. If this decrease reaches predetermined magnitude, this indicates the necessity of an adjustment.

Finally, an event which indicates the necessity of an adjustment can lie in the fact that a calculated wear exceeds a predetermined value. The wear of the friction linings can be calculated according to a model which includes one or more of the following variables: torque transferred by the clutch, slip, or temperature of the clutch.

It is understood that steps 62 and 64 can be executed in reverse order, that is, that first the necessity of an adjustment is checked and then it is determined whether the driving situation permits an adjustment. Step 64 can also stand at the start of the program and activate an adjustment program.

If it is decided that there should be an adjustment, the engagement bearing, or another control element of the clutch, is moved in step 66 by means of the actuation element beyond the normal displacement range into a position in which there is a displacement with the adjustment device internal to the clutch. The adjustment device internal to the clutch does not absolutely have to run automatically but rather can be carried out with the aid of additional actuators. It can also be done in such a manner that in the actuation path the effective length of a component is displaced.

The movement of the actuation element beyond the theoretical displacement range into the position in which, when there is sufficient wear, an adjustment takes place and which, for example, can be near to the position at which stop 34 (FIG. 1) limits additional movement of actuation element 16, can take place under different control processes:

Path control
The position sₘₐₓ (FIG. 3), at which an adjustment takes place, is, for example, stored in the control device as a target position to which the actuation element is moved in step 66. The advantage of this strategy lies in the fact that the position of the actuation element is known and always the same. The disadvantage is that under certain circumstances the actuation element is not moved enough to trigger an adjustment or cannot be moved into this position due to mechanical limitations of the system so that the electric motor 10 is overloaded.

Voltage control
A voltage-controlled movement into the adjustment position can, for example, be used in connection with a minimum speed to be maintained in order to produce a hard stop. The advantage of voltage control lies in the fact that there is a reduction in the risk that the actuation element traverses a displacement path which is too short or too long. The disadvantage lies in the fact that the end position of the actuation element is different since it depends on the wear of the clutch linings, the friction in the system, and additional forces acting on the actuator 10.

Speed control
A speed-controlled movement is similar to a voltage-controlled movement, where merely the control parameters are different. A hard stop is recognized by setting a maximum permissible voltage which is exceeded at the stop.

After the actuation element, or the engagement bearing, has been moved in step 66 into the adjustment position, or the area of the adjustment position, the program in step 68 goes over to slip control of the clutch, where the actuation element is once again moved in the normal displacement range of the clutch and the slip of the clutch is controlled. A reason for the transition to slip control is the fact that thereby it can be determined whether, in carrying out step 66, an adjustment has actually taken place. This adjustment causes a shift of the clutch torque curve (FIG. 3) from the solid curve to the dashed curve so that, if the actuation element returns to a position in which, before the adjustment, a certain clutch torque could be transferred and the clutch was in the slip state, then after the adjustment a greater torque can be transferred and the clutch would not slip. A disadvantage of the pure slip control in the return into the normal displacement range lies in the fact that the clutch goes over into the normal operational mode more slowly than would be the case when driving with the old clutch torque or motor torque. The combination of torque control and slip control is thus advantageous, whereby, first, the actuation element is rapidly moved back in the direction of the old position and then, toward the end, the return to the normal operational state can take place under slip control.

As soon as the clutch control has stabilized in step 68 and a constant slip can be maintained, it must be checked whether an adjustment of the clutch has taken place. If this is the case, there is a displacement of the lever spring relative to engagement bearing 46 (FIG. 2), which leads to a corresponding displacement of the characteristic curve for the clutch.

If it has been determined in step 70 that an adjustment has taken place, the engagement point, and thus the entire current characteristic curve for the clutch (solid line of FIG. 3), is shifted in such a manner that the new engagement point corresponds in turn to a transferable clutch torque of 5 Nm so that, assuming that the coefficient of friction has not changed, a curve, which is changed in the direction of the original theoretical curve or corresponds to it and, in particular, serves for rapid pilot control of the clutch, is stored in the control device as the new actual curve.

A shift of the actual characteristic curve with respect to the theoretical curve (FIG. 3) can be caused by wear as well as by a change of the adhesion factor of the friction lining. Such a change is normally compensated by the fact that with a predetermined, high motor torque a predetermined theoretical slip is set and, associated therewith, the position of the actuation element is updated as a new theoretical position.

The adjustment of the characteristic curve for the clutch as a consequence of an adjustment for wear is expediently done relative to the engagement point, where the changed actual position of the actuation element is once again brought to the theoretical position by running up to an operational point of 5 Nm. In so far as this is not possible, the actual curve is brought into agreement with the theoretical curve for another motor torque. The relationship between the displacement of the engagement bearing and the position of the actuation element depends on whether the action of a change of position of the actuation element on the clutch is load-based or position-based. FIG. 6 shows, in FIG. 6a, the load-based action of clutch lever 48 on clutch 10 and, in FIG. 6b, the position-based action of clutch lever 48 on clutch 10. As can be seen, respective two-arm clutch lever 48 in the load-based case is supported on spring 50, while, in contradistinction thereto, in the position-based case it is supported on counterbearing 52 at the end distant from the action of force F or displacement s. The type of clutch actuation is accordingly taken into account in the software.

In summary, with the invention a capability of compensating the wear of friction linings of a friction clutch is provided. If after a wear adjustment, internal to the clutch, which, for example, is done by actuating an actuation element beyond the normal displacement range of the clutch, there is once again a return to normal operation in which a constant slip is maintained, then it can be checked whether an adjustment has actually taken place. This can occur due to the fact that the calculated clutch torque is compared, at a certain position of the actuation element (based on an engagement point and a coefficient of friction which was determined before an adjustment), to the calculated actual torque at this position (derived from the motor torque). The difference between the two values would normally be attributed to a change in the coefficient of friction of the clutch but, in the case of an adjustment, it can be created by a shift of the clutch curve which has to be compensated by the engagement point being shifted. If the anticipated shift of the engagement point lies above a predetermined threshold value, it can be decided that an adjustment of the clutch has taken place and the engagement point can be shifted accordingly. The shift of the engagement point can be determined based on the shift at a position with higher torque if there is a constant relationship between the position of the actuation element and the position of the clutch engagement bearing. If this constant relationship does not exist, an offset value (a constant value or a value based on a characteristic curve) can be considered in addition in the engagement point shift.

### LIST OF REFERENCE NUMBERS

4 Lever spring
10 Clutch
12 Force-conducting mechanism
14 Electric motor
16 Actuation element
18 Bearing
20 Segmented wheel
22 Housing
24 Toothing
26 Output shaft
28 Spiral threading
30 Increment counter
32 Control device
34 Stop
36 Stop face
38 Stop face
40 Adjustment device
42 Lever spring
44 Engagement bearing
46 Friction lining
48 Clutch lever
50 Spring
52 Counterbearing

What is claimed is:

1. A process for adjusting a friction clutch located in a drive train of a vehicle and actuated by an actuator, said friction clutch comprising an adjustment device which, on moving an actuation element beyond a displacement range, effects a clutch adjustment compensating for friction lining wear, said process comprising the following steps:
determining whether the drive train of the vehicle is in a state in which an adjustment of the clutch is possible;
determining whether an adjustment of the clutch is necessary;
moving the actuation element beyond the theoretical range so that the adjustment device carries out an adjustment;
activating a slip-control process of the clutch;
determining whether an adjustment has taken place; and, updating the engagement point of the clutch.

2. The process recited in claim 1, wherein the friction clutch is pressed into its closed position by the actuation element and the adjustment device is activated by the actuation element being moved beyond a theoretical closed position of the clutch.

3. The process recited in claim 1, in which to determine that the vehicle drive train is in a state in which an adjustment of the clutch is possible it must be the case that at least one of the following operating states of the drive train obtains:
suspension of slip control is not critical;
the motor torque is less than a predetermined value;
the rotary speed of the clutch input shaft exceeds a minimum rotary speed;
the gear has been shifted longer than a predetermined period of time;
the slip is less than an upper limit value; or,
no shifting process is activated.

4. The process recited in claim 1, where the necessity of an adjustment of the clutch is determined by the period of operation of the clutch.

5. The process recited in claim 1, whereby the necessity of an adjustment of the clutch is determined by at least one of the following events:
reduction of the clutch torque which can be transferred during a predetermined actuation of the actuation element;
shift of the engagement point;
reduction of the force to be applied to the actuation element located at a predetermined position; or,
a calculated wear value exceeds a predetermined wear value.

6. The process recited in claim 1, where the actuation element is moved beyond the theoretical range according to one of the following control processes:
path control, force control, speed control.

7. The process recited in claim 1, where after carrying out an adjustment with a combination of torque control and slip control there is a return to slip control.

8. The process recited in claim 1, where it is checked whether an adjustment has taken place by at least one point of an actual characteristic curve for a clutch stored before the activation of an adjustment being compared to one point of a characteristic curve present after the adjustment.

9. The process recited in claim 8, where the actual characteristic curve is adapted according to the deviation.

10. A device for adjusting a friction clutch located in a drive train of a vehicle, actuated by an actuator, and comprising an adjustment device which, on moving an actuation element beyond a displacement range, effects a clutch adjustment compensating for friction lining wear, comprising the actuator (14) for actuating the actuation element (16), sensors for determining the clutch slip, the torque transferred by the clutch (10), and the position of the actuation element and an electronic control device (32) for controlling the actuator as a function of clutch slip, of clutch torque, and in given cases of additional operational parameters of the drive train, said control device comprising at least one characteristic curve for a clutch, said characteristic curve including the torque transferable by the clutch as a function of the position of the actuation element and being operatively arranged for carrying out a process for adjusting the friction clutch, said process comprising the following steps:
determining whether the drive train of the vehicle is in a state in which an adjustment of the clutch is possible;
determining whether an adjustment of the clutch is necessary;
moving the actuation element beyond the theoretical range so that the adjustment device carries out an adjustment;
activating a slip-control process of the clutch;
determining whether an adjustment has taken place; and,
updating the engagement point of the clutch.

11. The device recited in claim 10, where the clutch is a clutch comprised in a parallel shift gearbox.
